(19) United States
(12) Patent Application Publication
(10) Pub. No.: US 2013/0229076 A1
(43) Pub. Date: Sep. 5, 2013

(54) Miniature Motor and Bearing Arrangement

(71) Applicant: MULTIELECTRIC GMBH & CO. KG, Stuttgart (DE)

(72) Inventors: Dario BOCCADAMO, Stuttgart (DE); Joachim Friebe, Weinstadt (DE)

(73) Assignee: MultiElectric GmbH & Co. KG, Stuttgart (DE)

(21) Appl. No.: 13/775,366

(22) Filed: Feb. 25, 2013

(30) Foreign Application Priority Data
Mar. 5, 2012 (DE) 10 2012 101 819.7

(51) Int. Cl. H02K 5/173; H02K 15/00

(52) U.S. Cl. CPC H02K 5/1732; H02K 15/00
USPC 310/90; 29/596

(57) ABSTRACT

Electric miniature motor, comprises bearings; stationary assemblies having end faces; and metallic configurations for seating the bearings are formed at the end faces. At least one of the bearings is a roller bearing wherein the outer diameter of the roller bearing is smaller than the inner diameter of the corresponding configuration for seating the bearing; and the roller bearing is connected by at least one welded joint to the configuration.

### FIELD OF THE INVENTION

The present invention relates to electric miniature motors and a bearing arrangement for those.

### State of the art

Nowadays, miniature motors are used in various applications. Those include drives in home appliances, hand tools, actuators in motor vehicles and the like. The demands upon the motors are steadily increasing, including a lower noise generation besides a higher performance.

A major noise source can be the mounting of the rotor of the motor if axial and/or radial relative movements of the motor shaft can occur in the mounting positions for mounting the same. These movements are enabled by the tolerances required for fabricating the components of the motor, the reduction of which can only be obtained with a considerable cost effort.

Therefore, efforts have been made to minimize the mentioned relative movements without reducing the free movability of the shaft. Measures for achieving this object are described in EP 1 041 303 A1, DE 195 37 503 A1, DE 40 10 564 A1 and DE 10 2008 027 841 A1, for example. The solutions shown in these documents are still accompanied by a considerable effort regarding the components or the process.

The object of the present invention is thus to provide an electric miniature motor with a bearing system in which the bearing clearance of the shaft can be adjusted within narrow limits without the requirement that the individual components have to have narrow axial and radial tolerances.

It has now been found that this object can be achieved by fixing the bearing by welding, e.g. laser welding, in the bearing seat.

### SHORT DESCRIPTION OF THE INVENTION

The object of the present invention is an electric miniature motor, wherein metallic configurations for seating the bearings are formed at the end faces of the stationary assemblies and wherein at least one of the bearings is a roller bearing, e.g. a ball bearing, which is connected by welding, e.g. laser welding, to the configuration.

### SHORT DESCRIPTION OF THE FIGURES

FIG. 1 illustrates a longitudinal section of a miniature motor including the common assemblies according to an embodiment of the present invention;

FIG. 2 is a detailed view of the mounting according to FIG. 1 with the welded joint 2.3;

FIG. 3 illustrates a top view of the configuration 2.1 for receiving the ball bearing 2.2 with a point-like welded joint 2.3;

FIG. 4 is a view similar to FIG. 3 with an axially positioned corrugated welded joint 2.3;

FIG. 5 is a view similar to FIG. 3 with a corrugated welded joint 2.3 positioned at the circumference of the configuration 2.1;

FIG. 6 illustrates in a longitudinal section similar to FIG. 2 another embodiment of the invention with a front-sided welding between the ball bearing 2.2 and the configuration 2.1;

FIG. 7 illustrates in a longitudinal section similar to FIG. 2 another embodiment of the invention with a welding between the ball bearing 2.2 and the configuration 2.1 if the ball bearing 2.2 axially protrudes over the configuration 2.1;

FIG. 8 illustrates in a longitudinal section similar to FIG. 2 another embodiment of the invention with a welding between the ball bearing 2.2 and the configuration 2.1 if the ball bearing 2.2 is axially recessed behind the configuration 2.1;

FIG. 9 illustrates a top view according to FIGS. 6 to 8 with three welded joints 2.3.

### DETAILED DESCRIPTION OF THE INVENTION

A miniature motor according to the present invention substantially comprises a rotor assembly 1, a housing assembly 2 and a power transmission assembly 3. The components of these assemblies are sufficiently known from conventional motors and are thus only described here insofar as required for understanding the invention.

The housing assembly 2 and the power transmission assembly 3 have cylindrical configurations 2.1 and 3.1, respectively, receiving the bearings 2.2 and 3.2, respectively, in which in turn the shaft 1.1 of the rotor assembly 1 is mounted.

In the further description, it is exemplarily assumed that the bearing 3.2 is fixed in the cylindrical seat 3.1 and that the shaft 1.1 is axially displaceable in this bearing. Further, it is assumed that the bearing 2.2 is a ball bearing, and that it is to be positioned so that the axial movement of the rotor assembly 1 can be adjusted to a desired amount. For achieving this characteristic, the bearing 2.2 is fixed undisplaceably on the shaft 1.1 which can be achieved by a press fit, for example.

The inner diameter of the configuration 2.1 is larger than the outer diameter of the bearing 2.2, whereby it is possible that the rotor assembly 1 is still moveable in a mounted motor in which the housing assembly 2 is already fixedly connected to the power transmission assembly 3. This movement is possible axially and, in the limits of the diameter difference of the configuration 2.1 and the bearing 2.2, also radially.

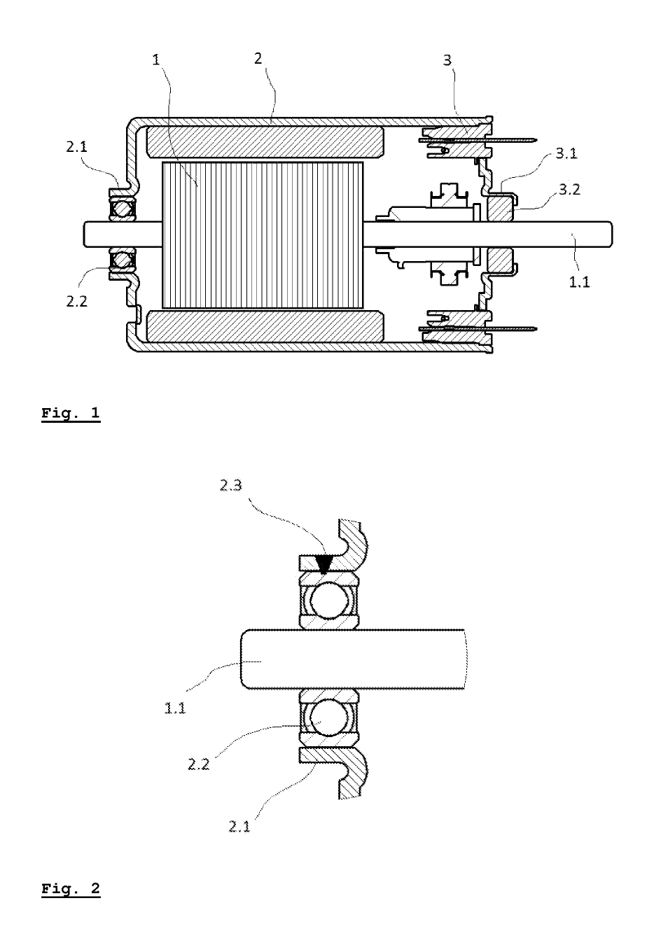

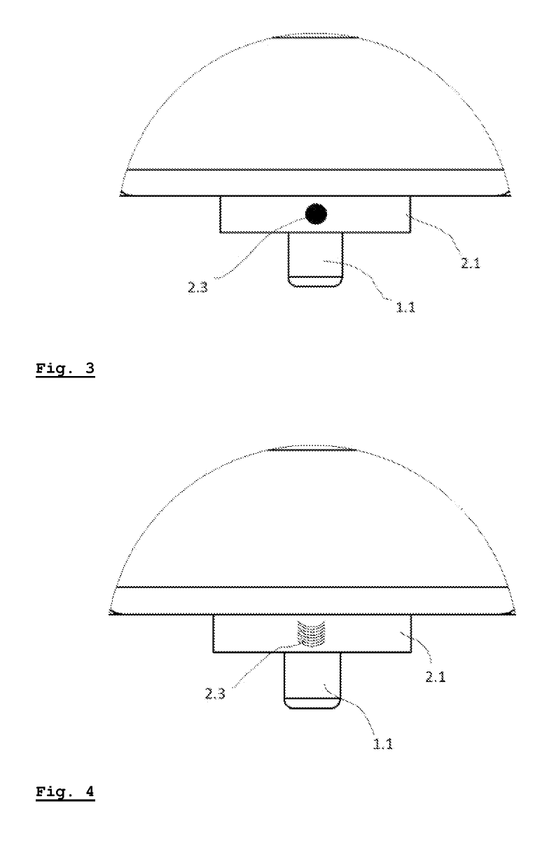

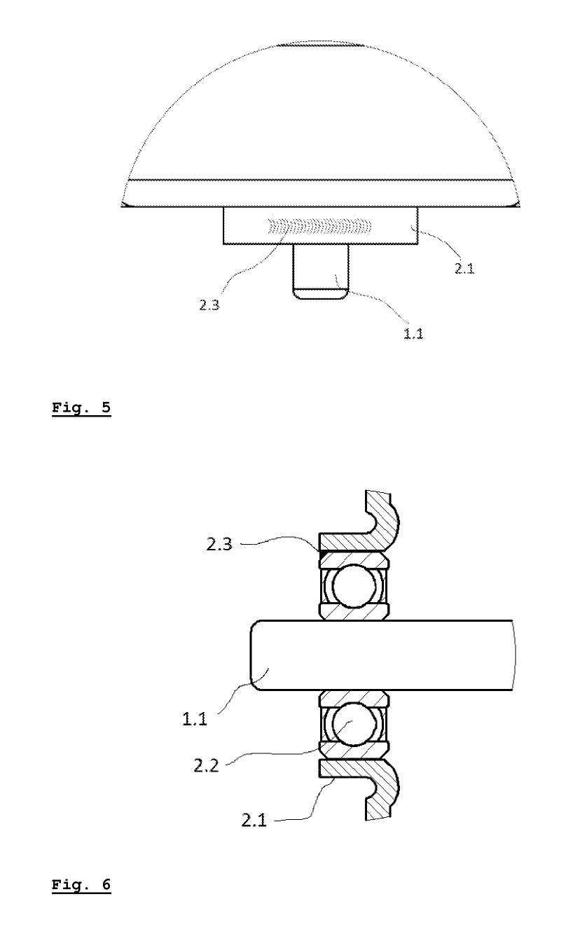

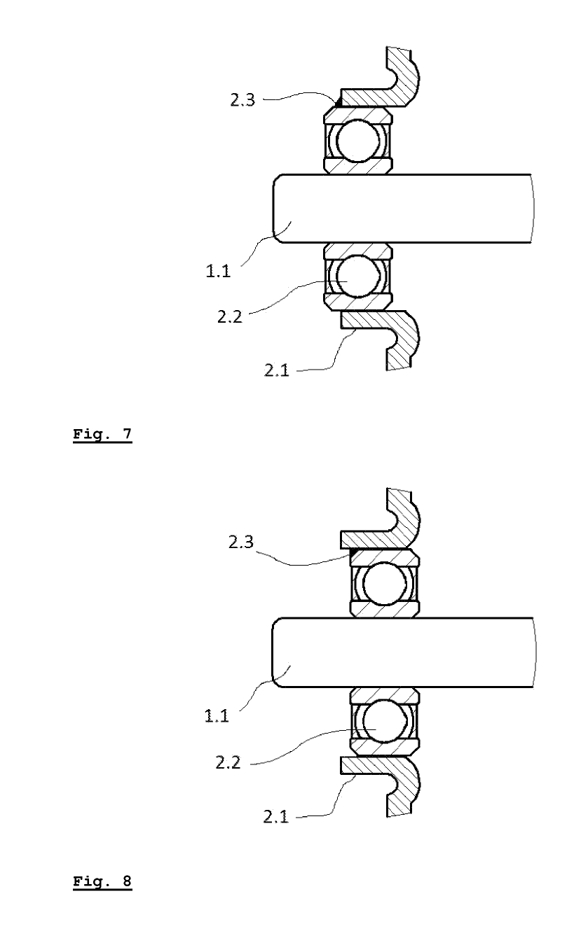

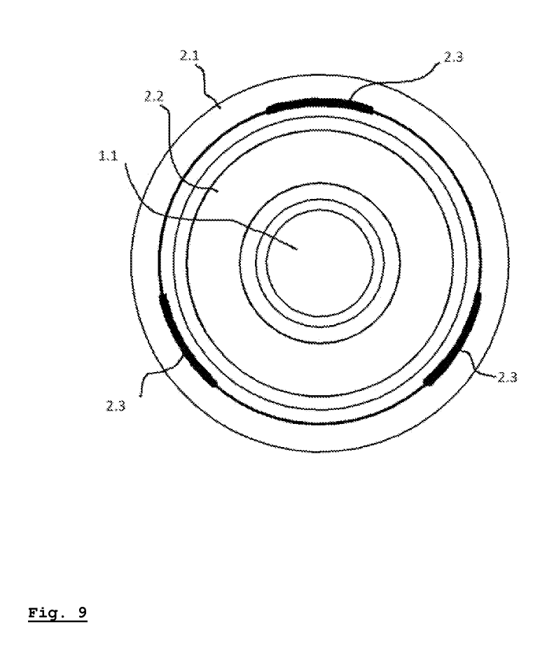

Using suitable means and devices, respectively, the rotor assembly 1 is brought into the desired position with respect to the housing assembly 2, and the outer ring of the ball bearing 2.2 is then welded to the configuration 2.1, e.g. by a laser beam. The welding 2.3 can occur both at the outer diameter of the outer ring of the ball bearing 2.2 through the configuration 2.1, i.e. in radial direction (FIGS. 2 to 5), and in axial direction at the contact edge between the outer ring and the configuration 2.1 (FIGS. 6 to 9). A combination of both welding directions is also possible. Each welded joint 2.3 can be point-like or corrugated, and it can be made at one or several positions or through a closed path.

Each individual welded joint 2.3 reaches a specific resistance against axial and radial forces acting upon the bearing 2.2. It is thus also possible to satisfy different requirements regarding these forces depending upon the use conditions of the motor by the number of welded joints 2.3 and their configuration or combination.

1. Electric miniature motor, comprising:
a) bearings;
b) stationary assemblies having end faces;
c) metallic configurations for seating the bearings are formed at the end faces;
d) at least one of the bearings is a roller bearing wherein the outer diameter of the roller bearing is smaller than the inner diameter of the corresponding configuration for seating the bearing; and
e) the roller bearing is connected by at least one welded joint to the configuration.

2. Electric miniature motor according to claim 1, wherein the welding occurs radially through the configuration with the outer ring of the roller bearing.

3. Electric miniature motor according to claim 2, wherein the welded joint is formed point-like, as an axial corrugation or as a corrugation at the circumference of the configuration.

4. Electric miniature motor according to claim 1, wherein the welding between the roller bearing and the configuration occurs at the contact edge between both components.

5. Electric miniature motor according to claim 4, wherein the welded joint is formed point-like or as a corrugation between the roller bearing and the configuration.

6. Electric miniature motor according to claim 1, wherein the welding between the roller bearing and the configuration occurs at several positions.

7. Bearing arrangement for an electric miniature motor, comprising:
a) a metallic configuration for seating a roller bearing at an end face of the stationary assemblies of the miniature motor;
b) a roller bearing having an outer diameter which is less than the inner diameter of the configuration; and
c) at least one welded joint connecting the roller bearing to the configuration.

8. Method for fabricating an electric miniature motor, comprising:
a) undisplaceably mounting a roller bearing on a shaft of the rotor assembly of the miniature motor;
b) positioning the roller bearing within a configuration for seating the roller bearing at an end face of the stationary assemblies of the miniature motor; and
c) welding an outer ring of the roller bearing to the configuration.

9. Method according to claim 8, wherein the welding of the outer ring of the roller bearing to the configuration occurs through the configuration.

10. Method according to claim 8, wherein the welding of the outer ring of the roller bearing to the configuration occurs at a front side at an end face of the stationary assemblies of the miniature motor at the contact edge of the two components.
